(19) United States
(12) Patent Application Publication
(10) Pub. No.: US 2023/0293369 A1
(43) Pub. Date: Sep. 21, 2023

(54) ANTI-BEDSORE MATTRESS WITH IMPROVED LOAD-BEARING COMPONENT

(71) Applicant: Boontham Nithi-uthai, Muang Pattani (TH)

(72) Inventor: Nattawut Nithi-uthai, Muang Pattani (TH)

(73) Assignee: Boontham Nithi-uthai, Muang Pattani (TH)

(21) Appl. No.: 17/688,923

(22) Filed: Mar. 8, 2022

(30) Foreign Application Priority Data
Jan. 26, 2022 (TH) 2203000194

(51) Int. Cl. A61G 7/057

(52) U.S. Cl. CPC A61G 7/05723

(57) ABSTRACT

An anti-bedsore mattress with the improved weight-bearing component consists of a mattress comprising triple layer of natural latex foam. The uppermost layer made of natural latex foam, with a density of 55-70 kilograms per cubic meter. The middle layer made of natural latex foam coated fabric, with a density of the natural latex foam of 100-120 kilograms per cubic meter. This layer contains at least one opening to reduce the pressure on the body when in use. The bottom layer consists of natural latex foam with the highest density between 70 to 100 kilograms per cubic meter with an opening positioned to accommodate the breech of the user and with a distributed placement of natural latex foam bars, combined with additional openings positioned to accommodate the heels of the user feet.

### FIELD OF THE INVENTION

The present invention relates to the field of engineering or the relevant materials science relating to anti-bedsore mattress with an improvement in the load-bearing component.

### BACKGROUND OF THE INVENTION

Many of the bedridden people we encounter today for instance the elderly with limited mobility or the disabled, who find it hard to move about. If these patients are spending most of the time on mattresses that do not adequately support them, pressure ulcers or bedsores could develop in those areas where their bodies come into contact with their mattresses. These pressure ulcers or bedsore develop where there is an imposition of force upon their bodies, inhibiting blood circulation leading to tissue death and the opening of wounds. Both the medical data and, especially, Thai Petty Patent Application Number 0503000511, Invention title “An Anti-bedsore mattress made from a fabric sewn into a grid compartment for rubber gloves for the insertion of water or air,” cited the factor leading to pressure ulcers, namely the impingement of localized pressure upon the body. If the pressure bearing on the body exceeds 35 millimeters of mercury in the affected area, the capacity of the blood to nourish that area will diminish. If the pressure exceeds 70 millimeters of mercury and lasts longer than two hours, the tissues of the body will receive an insufficient amount of nutrients and oxygen. Also, if the pressure exceeds 80 millimeters of mercury and continues for a long-enough length of time, the tissues will die and degrade into a bedsore.

In actual practice, caring for a bedridden patient, or a patient who is only barley able to move, requires turning the patient to a changed position to relieve the area that is under pressure and to allow the blood to flow through the affected area. If the patient is lying in a supine position, the patient should be turned every two hours; but if the patient is in a seated position, the pressure imposed upon the body will be higher than when lying down. In this case, the patient should be turned at a greater frequency, that is, every one-half hour. Assisting the patient for this purpose is time-consuming for the personnel who come to help turn the patient, especially since the patient must be turned throughout the entire 24-hour day. Consequently, the involved personnel are forced to devote an extensive amount of their time to this duty.

A search of the currently existing work shows that there have been quite enough patents that are related to mattresses designed to prevent pressure ulcers. These mattresses subdivide into two types, namely A) movable mattresses with padded surfaces and B) stationary mattresses with padded surfaces. Movable mattresses with padded surfaces include the following examples:

According to Chinese Patent Publication Number CN2070175U, Invention title “Anti-bed sore mattress” describes the use of round cylindrical air-filled channels contiguously arranged within the mattress, which are alternately pumped full and then decompressed.

According to German Patent Publication Number DE4207175A1, Invention title “Anti-bed sore mattress for bedridden patients” describes the use of contiguously arranged rectangular cylindrical air channels that are alternately raised and lowered.

According to Chinese Patent, Publication Number CN2131385 Y, Invention title “Anti-mattress sore air-filling mattress” describes a mattress with a surface consisting of contiguously arranged air-filled round buttons, in which air is alternately released and then refilled.

According to U.S. Pat. Publication Number US5233712A, Invention title “Pressure relief mattress”, or Thai Patent Application Number 0501000630, Invention title “Anti-bedsore patient bed” both describe a mattress designed so that the bed surface would consist of two sets of contiguously arranged transverse bars. When one set is raised, the other set is lowered by means of a hydraulic system. The time intervals of raising and lowering can be set between 1 and 30 minutes.

Further, there is the Japanese Patent Publication Number JP2000-189472, Invention title “Bed sore preventing apparatus” describes the use of bed cushions made from numerous air bags arranged in a row that are inflated and then deflated as a means of supporting the body weight of the patient at various points. Additional patents include U.S. Pat. Application No. US5815864, Invention title “Microprocessor controller and method of initializing and controlling low air loss floatation mattress”, U.S. Pat. No. US4825486, invention title “Bed sore preventing air mattress controller”, and Thai Patent Application number 0801004806, Invention title “Bedsore-prevention support pad with pressure and patient body-sinking control system.”

Nonetheless, while these adjustable bed surfaces system may be suitable for only patients who are unconscious because the continuously movement of the bed cushion, but not suitable for other patient that need sleep. In those cases where the patient is already experiencing pressure ulcers, the padded surfaces may come into contact with and press upon the area of the injury, not allowing the wound to heal, and may even cause the wound to widen further. In addition, in the event of an electrical power outage, the entire system would fail, causing an immediate impingement of pressure upon the patient.

Also, it might be well to consider some examples of patents for systems that involve no movement of the bed cushion. These rely on the principle of using a soft compliant material to undergird the body, thus reducing the amount of pressure being felt. Such examples include the following patents:

According to French Patent Publication Number FR2598910A1, Invention title “Anti-bed sore cushion or mattress” describes a mattress in the form of a gel with a thickness of 1-2 cm laid on a flexible foam sheet. Likewise, there is mention of the U.S. Pat. Publication No. US5636395A, Invention title “Mattress pad with gel filled chambers coupled to a foam cushion.” Also, there is the Chinese Patent Publication Number CN105640152A, Invention title “Mattress or mattress pad with gel section.”. However, the gel has limited capacity to absorb the pressure force being imposed on the body, as it is unable to lower the pressure below 100 milliliters of mercury. Accordingly, this subgroup of inventions cannot reliably correct the problem of bedsores resulting from the imposition of pressure.

Nonetheless, a Thai Patent Publication Number 0101002164, Invention title “Anti-bedsore mattress.” The application described a bedsore-prevention mattress containing balloons in its interior to undergird the patient body weight. Similarly, a Thai Patent Application Number 0503000511, for invention title “Anti-bedsore mattress.” The application in this instance referred to rubber gloves for the insertion of water or air into a rectangular grid compartment to reduce the pressure being borne by the patient. Both inventions are found to be flawed from the uncertainty of inserting water or air, making it impossible to control the amount of pressure being borne by the patient. Also, the material composition of the gloves or balloons is rather thin, leading to leaks or easy breakage, so that they must be constantly maintained.

From the information stated above it can be concluded that prior Anti-bedsore mattress inventions have drawbacks that make their operation inconvenient or require the use of an extensive amount of equipment. They otherwise require the use of electrical power, thus making their operation inconvenient everywhere. In particular, they are not truly capable of curing the problem of bedsores caused by the impingement of pressure, since they cannot reduce this pressure to a level below 100 millimeters of mercury. This invention has thus been developed to solve the above-mentioned problems by devising an Anti-bedsore mattress with an improvement in load-bearing component that would be made from natural latex foam. There would be improvements in various locations of the mattress so that it would be suitable for the task of bearing up under the weight of the user. Regardless of body shape, it would still be usable and capable of supporting the user both when lying in a supine position and when lying on the side.

### SUMMARY OF THE INVENTION

The Anti-bedsore mattress with the improvement in the load-bearing component is composed of three natural latex foam mattresses layered over one another. The upper-layer mattress is made from natural latex foam with a density ranging from 55 to 70 kilograms per cubic meter and a thickness of 2.5-6 centimeters. The middle-layer mattress is made from fabric coated with natural latex foam with a natural latex foam density between 100 and 120 kilograms per cubic meter and a thickness of 0.4-1.5 centimeters, and a bored opening in at least one position to support the body around the neck and shoulders, the coccyx and breech and/or the heels of the feet. Openings may be located in any one position or in several positions functioning together to reduce the pressure acting on the body when the device is in use. As regards the bottom-layer mattress, it is made from natural latex foam with a density ranging from 70 to 100 kilograms per cubic meter and a thickness of 2.5-7.5 centimeters. The section supporting the breech contains either a bored opening and a distributed placement of natural latex foam bars, or an opening that has been positioned to accommodate the breech of the user and a distributed placement of natural latex foam bars that have been combined with additional openings positioned to undergird the heels of the feet.

The objective of this invention is to prepare a pressure-ulcer preventive mattress with an improvement in the support component, which would be suitable for use, whether the patient is lying in the supine position and or lying on the side. The mattress would be capable of reducing the pressure imposed upon the patient’s body down to a level that would not be hazardous. Furthermore, it would be modified with openings on the middle-layer and lower-layer mattresses to reduce the pressure being imposed upon the various organs of the body that come into contact with the mattress when in use, which could help the patient avoid pressure ulcers when lying down, resting or getting treatment. Neither the manufacture nor the operation is complicated. It is therefore convenient to use. It is considered to be one more type of medical device that will help people in every locality to look after their personal health in an efficient manner.

### BRIEF DESCRIPTION OF THE DRAWINGS

FIG. 1: view of the Anti-bedsore mattress with the improved load-bearing component, made with a triple-layer of natural latex foam

FIG. 2: view of the upper layer of the Anti-bedsore mattress with the improved load-bearing component

FIG. 3: view of the middle layer of the Anti-bedsore mattress with the improved load-bearing component

FIG. 4: view of the middle layer of the Anti-bedsore mattress with the improved load-bearing component

FIG. 5: view of the bottom layer of the Anti-bedsore mattress with the improved load-bearing component

FIG. 6: view of the bottom layer of the Anti-bedsore mattress with the improved load-bearing component

FIG. 7: a description of the relationship of the natural latex foam density to the pressure resistance at 25% compression

### DETAILED DESCRIPTION OF THE INVENTION

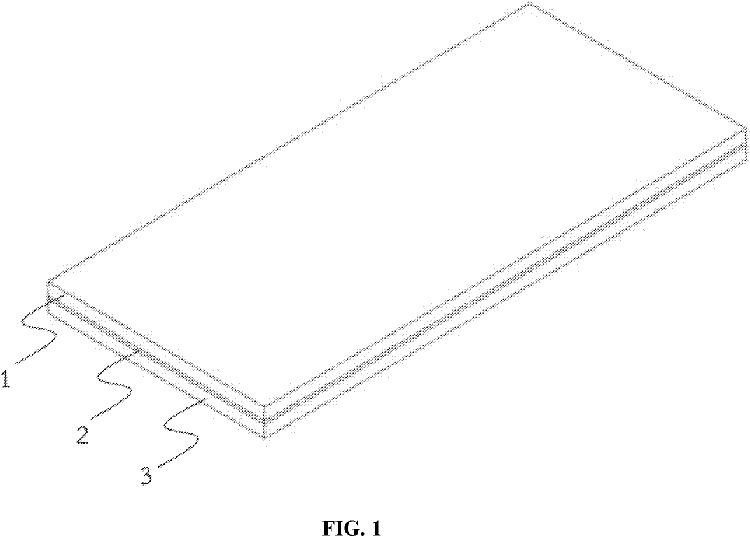

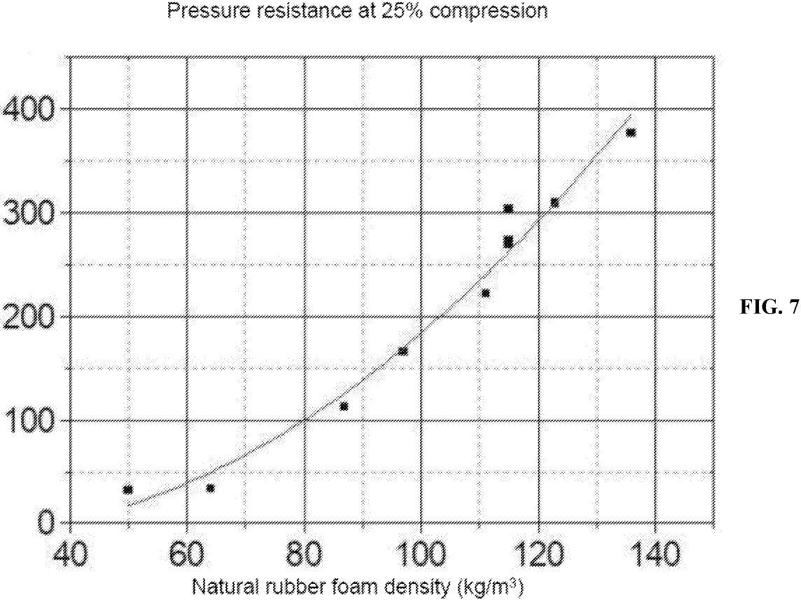

FIG. 1: The Anti-bedsore mattress with the improved load-bearing component is suitable for use whether the patient may be lying in the supine position or lying on the side of his (or her) body. It consists essentially in a triple-layer of natural latex foam, with an upper layer 1, a middle layer 2 and a bottom layer 3 bound together with Para-rubber adhesive with suitable dimensions of approximately 10 × 90 × 200 centimeters. (In general, the density of the natural latex foam is related to the rubber modulus, as shown in FIG. 7.) Details of each layer of the mattress are as follows:

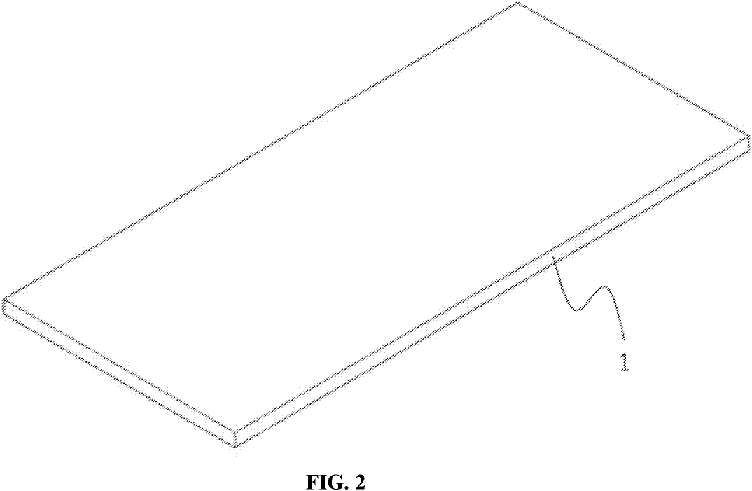

Upper layer 1, as shown in FIG. 2, is made from natural latex foam with a density of 55-70 kilograms per cubic meter, which is lower than that of the other layers, and a thickness 2.5-6 centimeters. This layer has the lowest density to make it soft for the user or patient when coming into contact with the mattress. This upper layer 1 can support the body weight of the patient or user at least partially. If, however, the body weight of the patient or user is greater, the downward force from the weight at that level simply passes downward to middle layer 2, which is situated between layers 1 and 3, and continues further downward to bottom layer 3.

In a preferred embodiment, the upper layer 1 is made to have a density of 65 kilograms per cubic meter and a natural latex foam thickness of 5 centimeters.

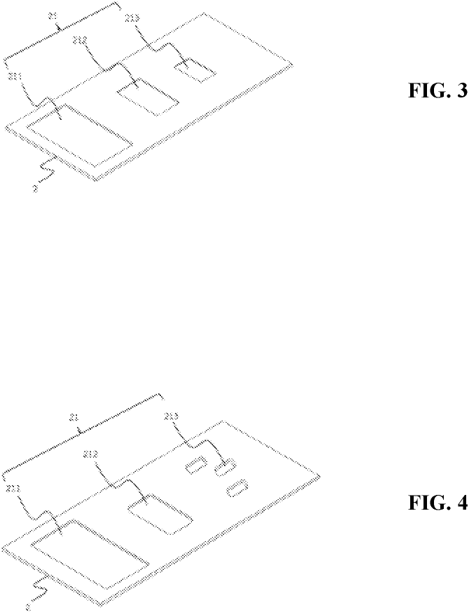

Middle layer 2, as shown in FIGS. 3 and 4, made of fabric coated with natural latex foam, with a natural latex foam density of 100-120 kg/m3 and thickness of 0.4-1.5 centimeters. Since middle layer 2 has only a small degree of flexibility, its function is to distribute the force from the patient (or user) body weight down to bottom layer 3. Furthermore, when there is direct pressure on the fabric, it creates an extensive amount of resistance, allowing the pressure impinging upon the body in this area to rise above the specified limit. For that reason, a bored opening 21 is installed in at least one position to reduce the amount of pressure being imposed upon the body whenever the mattress is in use. Its purpose is to release the resistance force bearing upon middle layer 2 in such a way that the area surrounding the bored opening would sustain and absorb this force to some extent. Whatever residual force there may still be would penetrate downward to bottom layer 3.

Middle layer 2 is formed from polyester fabric coated with natural latex foam

which is drawn tightly over the vulcanized natural latex foam and levelled off to a desired thickness. It is then baked and dried out. The thickness of the natural latex foam is set at 1.25 centimeters.

In an embodiment, the openings 21 in middle layer 2 is that it is formed with bored openings positioned to support the body around the neck and shoulders 211, the coccyx and breech 212 or the heels of the feet 213. An opening could be located in any one position, or there could be more than one positioned together in several positions.

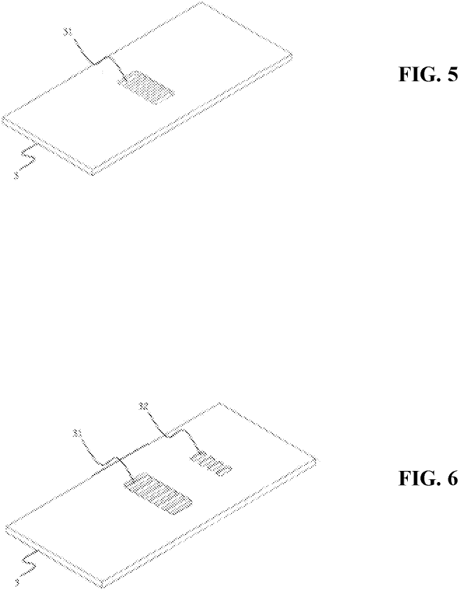

Bottom layer 3, as shown in FIGS. 5 and 6, is formed from natural latex foam with a density of 70-100 kilograms/cubic meter and a thickness of 2.5 -7.5 centimeters. The area supporting the breech is formed either with a bored opening 31 and a distributed placement of natural latex foam bars, or with the bored opening 31 and distributed placement of natural latex foam bars, combined with additional openings 32 positioned to accommodate the heels of the feet.

The natural latex foam bars have the same function as the spindle that pushes upper layer 1 into a flat sheet when there is no weight force bearing down upon the mattress. However, when there is a weight bearing down, such as from the breech of the patient for example, these natural latex foam bars will flatten down easily under the localized force with only minor resistance.

In a preferred embodiment, bottom layer 3 is made to have a density of 75 kilograms per cubic meter and a thickness of the natural latex foam of 5 centimeters.

In a preferred embodiment, the opening 31 undergirding the breech is made to have a thickness of 2.5 centimeters.

In a preferred embodiment, the natural latex foam bars consist of four bars, have a density of 65 kilograms per cubic meter and are distributed at least at 6 centimeters apart from each other.

The examples that will be presented from this point onward will demonstrate the development of the Anti-bedsore mattress with the improvement in the support component. This invention is not limited to what may apply to any one example, and what does apply to any example should not be taken as a limitation of the full scope of the invention.

Test of the Anti-bedsore mattress with the improvement in the support component in comparison to the features of other mattresses

Altogether, four models of the invention have undergone testing. Each model consisted of three material components, namely 1) a rubber foam layer with a density of 65 kilograms per cubic meter and a thickness of 5 centimeters, designated simply as “rubber foam D65”; 2) a rubber foam layer with densities of 100-120 kilograms per cubic meter with a thickness of 1.25 centimeters coated on fabric; and 3) a rubber foam layer with a density of 75 kilograms per cubic meter and a thickness of 5 centimeters, designated simply as “rubber foam D75.” Following are the details of all four models:
Mattress Model A: made of rubber foam D65 on the uppermost layer, with rubber foam D75 as the material of the middle layer and rubber foam overlaid with fabric on the bottommost layer
Mattress Model B: made of rubber foam D65 on the uppermost layer, with rubber foam overlaid with fabric as the material of the middle layer and rubber foam D75 on the bottommost layer
Mattress Model C: made of rubber foam overlaid with fabric on the uppermost layer, rubber foam D65 as the material of the middle layer and rubber foam D75 on the bottommost layer

Based on this invention, the Anti-bedsore mattress with the improvement in the support component consists of a layered arrangement like Mattress B, namely rubber foam D65 on the uppermost layer, rubber foam overlaid with fabric on the middle layer and rubber foam D75 on the bottommost layer. There is, however, an opening on the middle layer, that is, in the rubber foam overlaid with fabric, and a reduction in the midsection beneath the breech of the person using the rubber foam D75 cushion. This arrangement is further supplemented with the addition of four rubber foam D65 bars.

It was then time to conduct some tests with three test subj ects, one with a normal physique, one who was just plump and one who was clearly overweight. The test specimens were made to lie down on each of these four models. Measurements were then taken of the pressure in millimeters of mercury being imposed upon the backsides of their shoulders and breech, and on the heels of their feet. Pressure lower than 60 millimeters of mercury was generally considered to be quite low. If it ever exceeded 100 mm of Hg, however, it was then understood to be at a dangerous level and could lead to pressure ulcers. Results of these tests are as shown in Table 1.

TABLE 1

Pressure being borne on the backsides of the shoulders, breech and heels of test subjects with normal, plump and overweight body types while lying in the supine position on the four mattress models

| | Case No. | 1 | 2 | 3 |
|---|---|---|---|---|
| | Weight (kg) | 47.8 | 74.0 | 98.0 |
| | Height (cm) | 150 | 163 | 160 |
| | Body mass index (BMI) | 21.2 | 27.9 | 38.3 |
| Mattress A | Shoulders | 60 | 78 | 79 |
| | Breech | 64 | 117 | 106 |
| | Heels | <60 | 80 | 74 |
| Mattress B | Shoulders | 68 | 70 | 97 |
| | Breech | 81 | 102 | 115 |
| | Heels | <60 | 67 | 68 |
| Mattress C | Shoulders | 61 | <60 | 109 |
| | Breech | 101 | 115 | 116 |
| | Heels | 120 | 94 | 145 |
| Mattress based on this present invention | Shoulders | 62 | <60 | 93 |
| | Breech | 68 | 92 | 99 |
| | Heels | <60 | <60 | <60 |

It can be seen from the test results shown above in Table 1 that mattress models A and B were suitable for use by a person of light bodyweight. For the two people whose physiques were either on the plump side or overweight, however, the pressure force bearing on their breech exceeded 100 millimeters of mercury while lying on mattress models A, B and C. As for the mattress that was based on this invention, however, optimal pressure values were found on test subjects of every body type while lying on it.

At this point, another test was conducted on the pressure resulting from lying in the supine position upon this mattress that had been derived from the invention, using, this time, a total of 22 test cases. In bodyweight, they varied from 42.7 to 98 kilograms, with an average weight of 62.9 kilograms; in height, they varied from 145 to 163 centimeters, with an average height of 154 cm; and in body mass index (BMI), they varied from 19 to 38.3, with an average BMI of 26.4. Results of this test are as shown in Table 2.

TABLE 2

Test results from lying in the supine position of 22 test subjects on the mattress based on this invention

| No. | Weight (kg) | Height (cm) | Body mass index (BMI) | Shoulders | Breech | Heels |
|---|---|---|---|---|---|---|
| 1 | 42.7 | 150 | 19.0 | 63 | 70 | <60 |
| 2 | 47.2 | 150 | 21.0 | <60 | 70 | <60 |
| 3 | 47.8 | 150 | 21.2 | 62 | 68 | <60 |
| 4 | 49.2 | 152 | 21.3 | 64 | 78 | <60 |
| 5 | 54.7 | 160 | 21.4 | 66 | 83 | <60 |
| 6 | 53.3 | 152 | 23.1 | 67 | 77 | <60 |
| 7 | 61.7 | 163 | 23.2 | 77 | 89 | 75 |
| 8 | 57.9 | 155 | 24.1 | <60 | 90 | <60 |
| 9 | 59.5 | 156 | 24.4 | 69 | 83 | 62 |
| 10 | 63.0 | 160 | 24.6 | <60 | 84 | 81 |
| 11 | 55.8 | 150 | 24.8 | 61 | 72 | 67 |
| 12 | 57.4 | 150 | 25.5 | <60 | 74 | <60 |
| 13 | 61.8 | 155 | 25.7 | <60 | 69 | 70 |
| 14 | 58.4 | 150 | 26.0 | <60 | 66 | 66 |
| 15 | 60.1 | 150 | 26.7 | 62 | 80 | <60 |
| 16 | 74.0 | 163 | 27.9 | <60 | 92 | <60 |
| 17 | 71.0 | 156 | 29.2 | <60 | 86 | <60 |
| 18 | 65.2 | 145 | 31.0 | <60 | 87 | <60 |
| 19 | 80.6 | 160 | 31.5 | 80 | 94 | <60 |
| 20 | 77.0 | 150 | 34.2 | 84 | 91 | <60 |
| 21 | 88.5 | 155 | 36.8 | 67 | 92 | <60 |
| 22 | 98.0 | 160 | 38.3 | 93 | 99 | 70 |

It can be shown from the test results shown above in Table 2 that for people with either overweight or thin body types, the pressure being imposed upon all three areas of shoulders, breech and heels was below 100 millimeters of mercury. It can thus be seen that the mattress derived from this invention is usable for people of every body type when lying in the supine position. However, if the patient’s body is particularly large - weighing, perhaps, as much as 100 kilograms - some adjustment to the mattress may be necessary. For instance, a thicker layer of sponge D75 may be required at the very bottom. Alternatively, an additional layer of rubber foam with a density of 100-110 kilograms per cubic meter and a thickness of 5 centimeters could be used to provide supplementary support at the very bottom, combined with openings installed in the middle layer. These items may need to be expanded, as necessary, to accommodate the bodies of the individual users.

Also, in the event that the patient must alternate between lying in the supine position and on the side, it is possible to adjust the size of the openings in the middle and bottom layers. As shown in FIGS. 4 and 6, the openings have been widened, since from the moment that the patient is turned onto his or her side, the shoulders and hips are lying on a diagonal from the supine position. Accordingly, there needs to be an adjustment in the size of the gaps in the natural latex foam sheet at middle layer 2 and in the drilling of holes in the natural latex foam sheet in layer 3.

TABLE 3

Test results of lying alternately in the supine position and on the side of nine test subjects upon the mattress based upon this invention, with size adjustments in the gaps of the natural latex foam sheet in layer 2 and in the drilling of holes in the natural latex foam sheet in layer 3, in accordance with FIGS. 4 and 6

| No. | Weight (kg) | Height (cm) | Body mass index (BMI) | Pressure imposed by lying in the supine position (mm of Hg) | | Pressure imposed by lying on the side (mm of Hg) | |
|---|---|---|---|---|---|---|---|
| | | | | Shoulders | Breech | Shoulders | Hip |
| 1 | 47.8 | 150 | 21.2 | 63 | 69 | 100 | 88 |
| 2 | 54.7 | 160 | 21.4 | 66 | 80 | 137 | 111 |
| 3 | 55.8 | 150 | 24.8 | 78 | 86 | 110 | 92 |
| 4 | 60.1 | 150 | 26.7 | 67 | 63 | 75 | 119 |
| 5 | 63.0 | 160 | 24.6 | 84 | 69 | 90 | 84 |
| 6 | 65.2 | 145 | 31.0 | 65 | 72 | 90 | 81 |
| 7 | 71.0 | 156 | 29.2 | 72 | 84 | 87 | 115 |
| 8 | 74.0 | 163 | 27.9 | 51 | 88 | 126 | 91 |
| 9 | 80.6 | 160 | 31.5 | 67 | 87 | 93 | 115 |

It can be shown from the test results shown above in Table 3 that, in the mattress derived from this invention, there was an adjustment in the size of the gaps of the natural latex foam sheet in layer 2 and in the drilling of holes in the natural latex foam sheet in layer 3, in accordance with FIGS. 4 and 6. The (maximum) pressure impinging upon the shoulders and breech when lying in the supine position was at low level and did not exceed 90 millimeters of mercury. The (maximum) pressure impinging upon the shoulders and hips when lying on the side was within 75 and 137 millimeters of mercury (for some individuals). This figure was the maximum value for an area of one square centimeter. This same figure decreases in the surrounding areas, showing that there is poor circulation of the blood in those tiny areas. The pressure in the adjoining areas, however, indicates a normal circulation of the blood. Consequently, use of the mattress derived from this invention does not lead to dangerous levels of pressure on the user.

Any revisions in the form of modifications or improvements may be presented with a clear understanding and can be accomplished by those who possess the scientific expertise pertinent to this area. All of what has been said thus far lies within the scope and intent of this innovation, as also shown in the adherent claims.

### Best Mode of the Invention

The best mode of the invention is mentioned in detailed description of the invention.

What is claimed is:

1. An Anti-bedsore mattress featuring the improved load-bearing component consists of a triple-layer of natural latex foam mattresses,
wherein it is characterised in that: an upper layer (1) made of natural latex foam with a density of 55-to-70 kilograms/cubic meter; a middle layer (2) is formed from natural latex foam overlaid with fabric with a natural latex foam density of 100-120 kilograms/cubic meter and a bored opening (21) in at least one position to reduce the amount of pressure imposed upon the body when in use; and a bottom layer (3) is formed from natural latex foam with a density of 70- 100 kilograms/cubic meter.

2. The improved load-bearing component of anti-bedsore mattress according to claim 1, wherein the middle layer (2) is formed from natural latex foam overlaid with a polyester fabric which is drawn tightly over the vulcanized natural latex foam and levelled off to a desired thickness; It is then baked and dried out.

3. The improved load-bearing component of anti-bedsore mattress according to claim 1, wherein the middle layer (2) is formed with bored openings (21) positioned to support the body around the neck and shoulders (211), the coccyx and breech (212) or the heels of the feet (213); An opening could be located in any one position or there could be more than one together in several positions.

4. The improved load-bearing component of anti-bedsore mattress according to claim 1, wherein the bottom layer (3), where it supports the buttocks, is formed either with a bored opening (31) and a distributed placement of natural latex foam bars, or with the bored opening (31) and distributed placement of natural latex foam bars, together with openings (32) positioned to support the heels of the feet.

5. The improved load-bearing component of anti-bedsore mattresses according to claim 4, wherein the appropriate number of natural latex foam bars is set at four, each of which has a density of 65 kilograms per cubic meter.

6. The improved load-bearing component of anti-bedsore mattresses according to claim 4, wherein the appropriate distribution of the natural latex foam bars is defined, with intervals of separation among the individual bars of no less than 6 centimeters.

7. The improved load-bearing component of anti-bedsore mattresses according to claim 1, wherein the upper layer (1) is formed from natural latex foam having a thickness of 2.5 -6.0 centimeters.

8. The improved load-bearing component of anti-bedsore mattresses according to claim 1, wherein the middle layer (2) is formed from natural latex foam having a thickness of 0.4 -1.5 centimeters.

9. The improved load-bearing component of anti-bedsore mattresses according to claim 1, wherein the bottom layer (3) is formed from natural latex foam having a thickness of 2.5 - 7.5 centimeters.

10. The improved load-bearing component of anti-bedsore mattresses according to claim 1, wherein the thickness of the bottom layer (3) in the area where the openings (31) are positioned to support the buttocks is 2.5 centimeters.
